(19) United States
(12) Patent Application Publication
(10) Pub. No.: US 2009/0148224 A1
(43) Pub. Date: Jun. 11, 2009

(54) Marking apparatus

(76) Inventors: Thomas Steiger, Luechingen (CH); Martin Lippuner, Rebstein (CH); Maximilian Stoeck, Azmoos (CH); Christoph Wuersch, Werdenberg (CH)

Correspondence Address: ABELMAN, FRAYNE & SCHWAB, 666 THIRD AVENUE, 10TH FLOOR, NEW YORK, NY, 10017, US

(21) Appl. No.: 12/313,655

(22) Filed: Nov. 20, 2008

(30) Foreign Application Priority Data
Nov. 21, 2007 (DE) 10 2007 055 502.6

(51) Int. Cl. B43M 11/00

(52) U.S. Cl. 401/198

(57) ABSTRACT

A marking apparatus displaceable along a surface (1), comprising a pen-shaped reservoir (6), of a marking liquid (5) and having a porous stylus (12); and a marking device (4) for applying the marking liquid (5) to the surface (1) from the pen-shaped reservoir (6), the marking device (4) having, a nozzle (9) located adjacent to the porous stylus (12), a valve (8) for connecting the nozzle (9) with a gaseous pressure medium (13), and computing means (7) for controlling the valve (8).

### BACKGROUND OF THE INVENTION

1. Field of the Invention

The present invention relates to a marking apparatus which is displaceable along a surface for applying permanently visible markings to this surface, particularly to walls, ceilings, floors made of concrete, masonry, wood, tiles, aerated concrete, sandy limestone, plaster, carpeting, etc. in the building industry and related services.

2. Description of the Prior Art

In the building industry, marks are usually placed on surfaces with chalk sticks, sprays, chalk lines, pencils, felt pens, etc. This may be suitable in rare instances, but not for automated processes for applying a large number of marks.

Marking apparatuses of the type mentioned above are often combined with position-dependent detectors which automatically apply a mark to the surface by means of a marking device in case of a detection event, for example, when iron reinforcements or pipes are detected in the wall, or when a laser beam of a rotary laser is detected for marking exactly positioned fastening points.

According to U.S. Pat. No. 6,373,244, a manually driven marking apparatus, which is movable on wheels along a surface, has a position-dependent detector in the form of a magnetic subsurface detector or, according to U.S. Pat. No. 5,829,147, in the form of a photosensor array. Depending on the position of the detected object, one or more nozzles spray a colored marking on the surface by means of the marking device which is controlled automatically by valves which are connected to computing means. For this purpose, the controllable nozzles are connected to a dye reservoir in the form of a tank which is under inherent pressure.

Further, German Utility Model DE 297 07 868U discloses a device for airbrushing in which a porous (capillary) stylus of clamped felt pen having a marking liquid reservoir which is filled with a colored marking liquid, is associated with a compressed-air nozzle that extends at an angle of 70° to the air flow through the porous stylus.

### SUMMARY OF THE INVENTION

It is the object of the invention to further optimize the marking device and to provide a robust construction of the marking device, and a method suitable for use on construction sites.

A further object of the present invention is to provide a marking device suitable for applying marks on all common smooth or rough surfaces in any orientation with up to 20 marks per second within a temperature range of −10° C. to +50° C., which marks have good visibility and high contrast.

Another object of the present invention is a marking device that requires no maintenance apart from a simple and intuitive replenishment of the depleted marking liquid. Another aspect consists in changing the color of the marking liquid in a simple manner.

This and other objects of the present invention, which will become apparent hereinafter, are achieved by providing a marking apparatus which is displaceable along a surface and has a marking device for applying a marking liquid on the surface from a marking liquid reservoir, which marking device contains at least one (pneumatic) valve which is controllable by computing means, and a nozzle connected to this valve, with the marking liquid reservoir having a porous stylus with an associated nozzle adjacent to it, this nozzle being connected to a gaseous pressure medium by a valve. The marking liquid reservoir may be formed as a pen which is insertable in a pen holder.

The marking apparatus is built to be more robust and suitable for use on construction sites by the construction of the marking device for airbrushing with porous styluses of commercially obtainable, reliable pens (in particular, markers) which are available throughout the world. Further, the pens can be changed very easily, and the marking apparatus can accordingly also be used with different marking liquids with respect to colors, solvents, washability, etc., wherein the pens can always be reused and, as such, usually refilled in an economical manner.

The marking apparatus advantageously has a position-dependent detector which is connected to computing means so that an automatic marking can be carried out in case of a detected event.

The nozzle axis advantageously forms a spray angle in the range from 70° to 82° with the axis of the pen-shaped reservoir, which has been proven optimal in trials for airbrushing with porous styluses.

In an advantageous manner, the pen axis is inclined relative to the surface at an inclination angle in the range from 25° to 40°, so that the gas jet deflected by the stylus impinges on the surface perpendicularly and, therefore, enables an exact positioning.

The distance of the porous stylus from the surface is advantageously in the range of 3 mm to 30 mm, optimally 5 mm, so that a mark size that is suitable for the construction industry is carried out with good contrast and sufficient accuracy.

The nozzle axis advantageously intersects with the porous stylus centrically so that the air flow does not experience lateral deflection.

The diameter of the nozzle is advantageously between 1.0 mm and 2.0 mm, and the gas pressure which is used is between 0.8 bar and 2.5 bar on the pressure side in front of the valve so that the gas jet is optimized for the capillary action at the porous stylus.

The pressure-side end of the valve is advantageously connected by a reducing valve to a pressure reservoir and, even more advantageously, to a compressed-gas bottle so that the required gas pressure is provided at the pressure-side end of the valve with a compact, light, commercially available compressed-gas bottle (e.g., at 250 bar) in a simple manner and without moving parts (e.g., with pump-generated pressure, which is likewise possible) for a long use period.

The pressure medium is advantageously standard compressed air so that the usual air composition remains unchanged also in closed spaces, although other pressure media such as oxygen, nitrogen, carbon dioxide, propane, etc. can also be used in principle.

In an advantageous manner, the marking device has a plurality of nozzles which are offset parallel to one another and which are connected with valves and associated pen holders in which styluses can be inserted so that when the marking apparatus is displaced, a plurality of (offset) marks can be applied simultaneously, e.g., using subsurface scanners. Further, (identically positioned) marks can be made with different marking liquids, if desired, in a control-dependent or event-dependent manner without having to change the pen, e.g., with active laser detectors.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of marking apparatus according to the present invention; and

FIG. 2 a side view of marking device of the marking apparatus according to FIG. 1.

### DETAILED DESCRIPTION OF THE PREFERRED EMBODIMENT

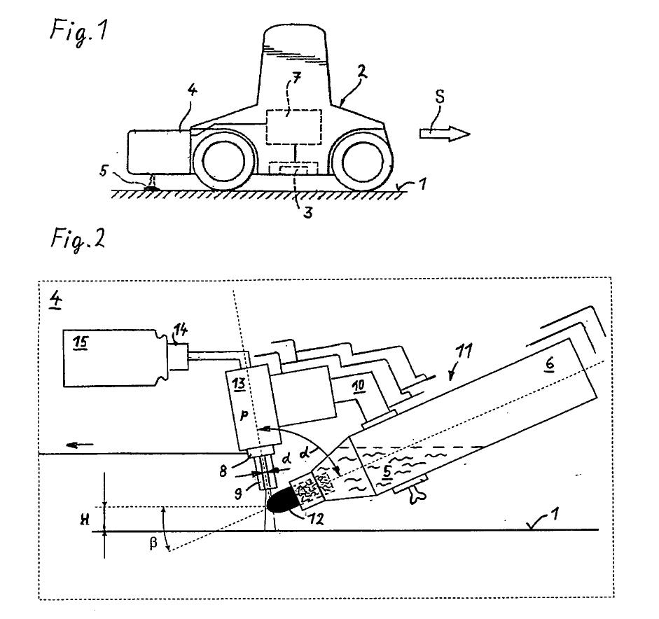

According to FIG. 1, a hand-held marking apparatus 2 in the form of a subsurface detector, which is movable along a surface 1 in a scanning direction S, has a position-dependent detector 3 in the form of an ultra wideband (UWB) subsurface radar which is connected to computing means, and a marking device 4 which is controlled by the computing means 7 and which is used for applying a marking liquid 5 to the surface 1.

In the marking device 4 for applying a marking liquid 5 from a marking liquid reservoir 6 to the surface 1 according to FIG. 2, the marking fluid reservoir 6 may be a pen 11 in the form of a commercially available marker which is inserted in a pen holder 10 and has a porous stylus 12 of felt. The nozzle 9 having a diameter d of 1.5 mm is associated with this porous felt stylus 12 so as to be arranged adjacent to it and is connected to a gaseous pressure medium 13 in the form of compressed air at a gas pressure p of 1.5 bar by the valve 8 in the formed as a pneumatic valve which is controlled by the computing means 7 (FIG. 1). The pressure-side end of the valve 8 is connected by a reducing valve 14 to a pressure reservoir 15 in the form of a commercially available compressed-air bottle with internal pressure of 250 bar. The nozzle axis D forms a spray angle α of 75° with the pen axis A. The pen axis A itself is inclined by an angle β of 30° relative to the surface. The distance H of the porous stylus 12 from the surface 1 is 5 mm. The nozzle axis D intersects the porous stylus 12 centrically. A plurality of nozzles 9 (only shown schematically) which are offset parallel to one another are provided in the marking device 4. The nozzles 9 are connected with valves 8 and are associated with pen holders 10 into which pens 11 are inserted.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A marking apparatus displaceable along a surface (1), comprising a pen-shaped reservoir (6), of a marking liquid (5) and having a porous stylus (12); and a marking device (4) for applying the marking liquid (5) to the surface (1) from the pen-shaped reservoir (6), the marking device (4) having, a nozzle (9) located adjacent to the porous stylus (12), a valve (8) for connecting the nozzle (9) with a gaseous pressure medium (13), and computing means (7) for controlling the valve (8).

2. A marking apparatus according to claim 1, wherein the pen-shaped reservoir is formed as a pen (6), and the marking device (4) has a pen-holder (10) for receiving the pen (11).

3. A marking apparatus according to claim 1, further comprising a position-dependent detector (3) connected to the computing means (7).

4. A marking apparatus according to claim 1, wherein a nozzle axis (D) forms with an axis (A) of the pen-shaped reservoir (6) a spray angle (α) in the range of 70° to 82°.

5. A marking apparatus according to claim 1, wherein a pen axis (A) is inclined relative to the surface (1) at an inclination angle (β) in the range from 25° to 40°.

6. A marking apparatus according to claim 1, wherein a distance (H) of the porous stylus (12) from the surface (1) is in the range from 3 mm to 30 mm.

7. A marking apparatus according to claim 1, wherein a nozzle axis (D) intersects with the porous stylus (12) centrically.

8. A marking apparatus according to claim 1, wherein a diameter of the nozzle (9) is between 1.0 mm and 2.0 mm, and a used gas pressure (p) is in a range between 0.8 bar and 2.5 bar on a pressure side in front of the valve (8).

9. A marking apparatus according to claim 7, wherein a pressure-side end of the valve (8) is connected by a reducing valve (14) to a pressure reservoir (15).

10. A marking apparatus according to claim 1, wherein a pressure medium (13) is compressed air.

11. A marking apparatus according to claim 1, comprising a plurality of pen-shaped reservoirs (6), wherein the marking device (4) has a plurality of pen holders (10) for receiving respective pen-shaped reservoirs (6), a plurality of nozzles (9) located adjacent to porous styluses (12) of the respective pen-shaped reservoirs (6), and a plurality of valves (8) for connecting respective nozzles (9) with the gaseous pressure medium (13).
